(19) United States
(12) Patent Application Publication
(10) Pub. No.: US 2009/0207849 A1
(43) Pub. Date: Aug. 20, 2009

(54) COMMUNICATION SYSTEM

(76) Inventor: Masaharu Tamatsu, Tama City (JP)

Correspondence Address: APEX JURIS, PLLC, 12733 LAKE CITY WAY NORTHEAST, SEATTLE, WA, 98125, US

(21) Appl. No.: 12/369,631

(22) Filed: Feb. 11, 2009

(30) Foreign Application Priority Data
Feb. 14, 2008 (JP) JP2008-032932

(51) Int. Cl. H04L 12/56

(52) U.S. Cl. 370/400

(57) ABSTRACT

The invention provides a communications system with few transmission collisions. The communications system is provided with a rhythm node, which rhythm nodes transmit synchronized upstream transmission instigation messages, upon receipt of which dominant nodes perform upstream transmissions sequentially and after their predetermined standby times. The rhythm node transmits synchronized downstream transmission instigation messages, upon receipt of which tonic nodes perform downstream transmissions sequentially and after their predetermined standby times. Transmissions of upstream transmission instigation messages and downstream transmission instigation messages are synchronized. Transmissions are efficient and without collisions because individual nodes perform transmissions in sequence rather than instantaneously.

### CROSS-REFERENCE TO RELATED APPLICATION(S) AND CLAIM OF PRIORITY

The present application claims the benefit under 35 U.S.C. section 119(a) of Japanese Patent Application filed in the Japan Patent Office on Feb. 14, 2008 and assigned serial number 2008-032932, the disclosure of which is incorporated herein by reference.

### FIELD OF THE INVENTION

The invention relates to transmission methods, providing for high-speed transmissions between nodes.

### DESCRIPTION OF RELATED ART

Conventional transmission protocols include the BSC and HDLC protocols, long used primarily with mainframe computers, and the TCP/IP protocols used on the Internet that are now becoming mainstream. Collision detection schemes, such as CSMA/CD, employing TCP/IP may be utilized in a range of communications, including local-area and wide-area networks; due to the ease with which transmission collisions occur, however, they fail to take full advantage of the performance of transmission paths. This tendency grows particularly acute when communications begin to grow congested, and only one in several tens of actual transmission capacity may be achieved. One aspect of such systems is that their capacity falls off when it is most needed. The inventor has disclosed invention of a communications system (cf. Patent Document 1) that eliminates transmission collisions and secures the maximum performance of transmission paths by dividing transmissions into upstream transmissions and downstream transmissions and situating along transmission paths a node termed a rhythm node that sends upstream transmission instigation messages.

### Patent Document 1

WO/2005/094010

### DISCLOSURE OF THE INVENTION

The present invention consists in effecting high-speed transmissions between nodes. The present invention further consists in effecting efficient transmission and enabling high-speed transmissions on communications networks linking large numbers of nodes by means of reducing transmission collisions.

An embodiment of the present invention is a communications system and transmission method comprising a rhythm node that transmits upstream transmission instigation messages and downstream transmission instigation messages, multiple dominant nodes that transmit data upon receipt of an upstream transmission instigation message, multiple tonic nodes that transmit data upon receipt of a downstream transmission instigation message, and transmission paths, in which the rhythm node transmits upstream transmission instigation messages, the individual dominant nodes, upon receiving an upstream transmission instigation message, transmit data in upstream transmissions after their individual predetermined standby times, the rhythm node transmits downstream transmission instigation messages, and the individual tonic nodes, upon receiving a downstream transmission instigation message, transmit data in downstream transmissions after their individual predetermined standby times, and in which the transmission of upstream transmission instigation messages and the transmission of downstream transmission instigation messages are synchronized.

### BRIEF DESCRIPTION OF THE DRAWINGS

The above and other objects of the present invention will become readily apparent by reference to the following detailed description when considered in conjunction with the accompanying drawings wherein:

FIG. 1 is a time chart describing the mechanism by which collisions are averted in “A communications system”;

FIG. 2 is a typical network diagram;

FIG. 3 is a time chart of upstream transmission and is paired with FIG. 4;

FIG. 4 is a time chart of downstream transmission and is paired with FIG. 3;

FIG. 5 illustrates an example of employing a rhythm node for downstream transmission instigation messages and a rhythm node for upstream transmission instigation messages;

FIG. 6 illustrates an example of transmission permissions allocation with an upstream transmission instigation message;

FIG. 7 is a time chart of the use of downstream transmission sequence numbers in downstream transmission;

FIG. 8 illustrates an example of a downstream transmission instigation message;

FIG. 9 illustrates an example of the use of a single rhythm node in a large network;

FIG. 10 illustrates an example of the use of a single rhythm node and of a final communications apparatuses in a large network;

FIG. 11 illustrates an example of the use of a master rhythm node and subordinate rhythm nodes in a large network;

FIG. 12 illustrates an example of the use of multiple rhythm nodes and asynchronous transmissions between them in a large network;

FIG. 13 illustrates an example of a large network;

FIG. 14 illustrates an example of intermediate communications apparatus configuration;

FIG. 15 illustrates an example depicting broker functionality;

FIG. 16 illustrates an example of a transmission storage region; and

FIG. 17 illustrates an example of prioritized frame transmission in a transmission storage region.

### PREFERRED EMBODIMENTS OF THE INVENTION

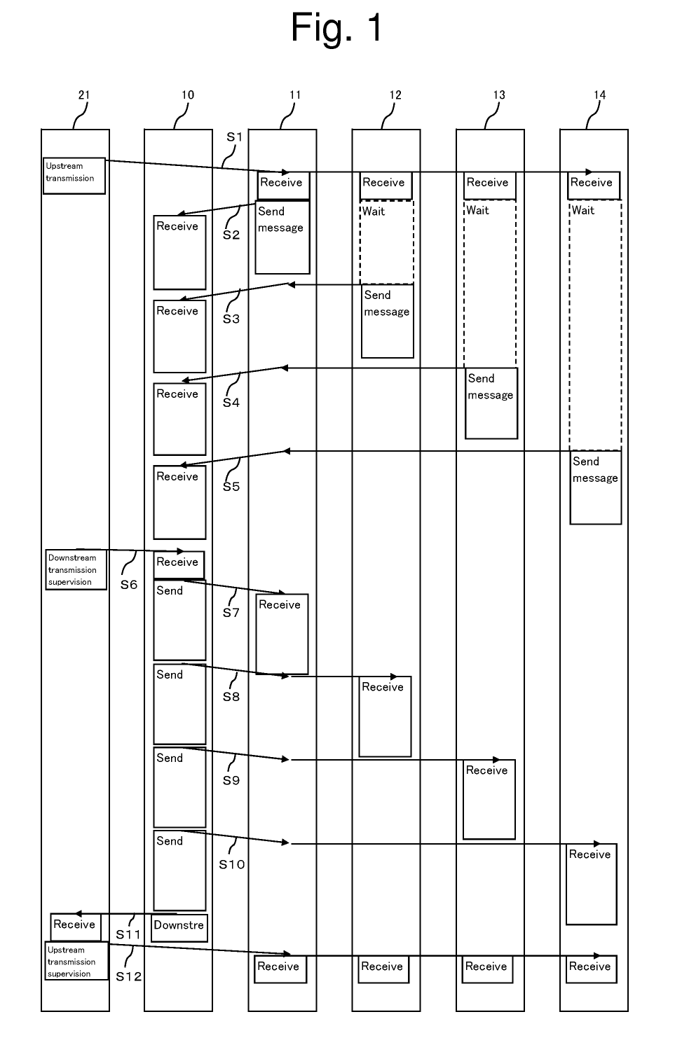

The communications system referenced in the description of related art eliminates transmission collisions and secures the maximum performance of transmission paths by dividing transmissions into upstream transmissions and downstream transmissions and situating along transmission paths a node termed a rhythm node that sends upstream transmission instigation messages (see FIG. 1); where such a communications system performs full-duplex transmissions, it separates transmissions internal to a network into upstream transmissions and downstream transmissions, and employs upstream transmission paths for upstream transmissions and downstream transmission paths for downstream transmissions. Nodes connected to a network are classified into tonic nodes and dominant nodes. Tonic nodes are connected to one end of a network, and dominant nodes to the other end. Transmissions from tonic nodes to dominant nodes are downstream transmissions, and transmissions from dominant nodes to tonic nodes are upstream transmissions. Where the communications system performs half-duplex transmissions, the division into upstream transmissions and downstream transmissions is likewise to that for full-duplex transmission, but upstream transmission and downstream transmission are performed alternately, downstream transmissions performed after upstream transmissions have been performed, due to the availability of only a single transmission path.

Tonic nodes are generally reckoned servers. Dominant nodes are generally reckoned client personal computers. However, servers may be connected as dominant nodes, and client personal computers may be connected as tonic nodes. “Tonic node” and “dominant node” are relative concepts used to segregate upstream transmissions and downstream transmissions. Dominant nodes are those nodes that perform upstream transmissions upon receipt of an upstream transmission instigation message from the rhythm node.

Collisions between upstream transmissions are averted by the rhythm node sending upstream transmission instigation messages and dominant nodes in receipt thereof sequentially performing upstream transmissions after their individual predetermined standby times. Collisions between downstream transmissions are averted by the rhythm node assigning downstream transmission permissions to tonic nodes and performing downstream transmissions sequentially. However, as upstream transmission instigation messages travel in the same direction as downstream transmissions on this network, collisions may occur between upstream transmission instigation messages and downstream transmissions. And as allocations of downstream transmission permissions travel in the same direction as upstream transmissions on this network, these too may collide with upstream transmissions. The present invention consists in eliminating such collisions and achieving greater efficiency in transmissions.

It is due to the loss of accuracy by server and personal computer clocks, on the order of about one second per day, that control of transmissions is thus performed by means of a rhythm node. If there were no clock deviation, it would be possible to control transmissions by means of the nodes' clocks, by allocating each node a time slot referencing the time common to all nodes, but where deviation obtains, disagreement among clocks results in transmission collisions. Transmission utilizing a rhythm node enables high-speed transmissions with little adverse effect of clock deviation as collisions between transmissions need only be averted during the brief period between receipt of a transmission instigation message and the completion of transmissions.

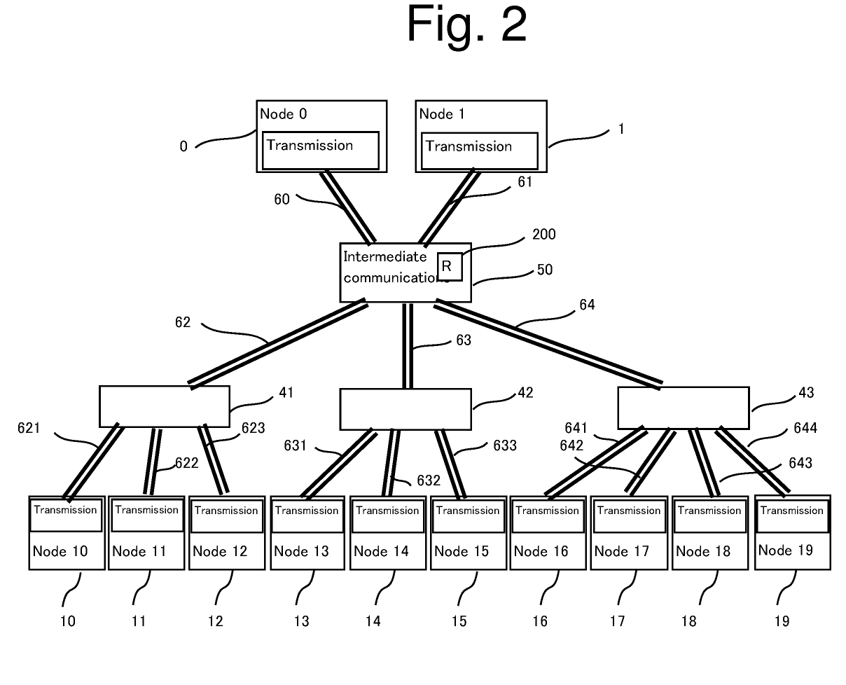

In other words, the system comprises a rhythm node that transmits upstream transmission instigation messages and downstream transmission instigation messages, multiple dominant nodes that transmit data upon receipt of an upstream transmission instigation message, multiple tonic nodes that transmit data upon receipt of a downstream transmission instigation message and transmission paths, in which the rhythm node transmits upstream transmission instigation messages, the individual dominant nodes, upon receiving a transmission instigation message, transmit data in upstream transmissions after their individual predetermined standby times, the rhythm node transmits downstream transmission instigation messages, and the individual tonic nodes, upon receiving a downstream transmission instigation message, transmit data in downstream transmissions after their individual predetermined standby times, and in which the transmission of upstream transmission instigation messages and the transmission of downstream transmission instigation messages are synchronized. FIG. 2 illustrates a representative such network. The communications systems and transmission protocols to which the present invention applies are not limited to TCP/IP and CSMA/CD.

### Terminology

This specification describes methods for implementing the communications system. The purpose therein is to facilitate understanding of the operations of apparatus to which those methods are applied; the invention is not confined to these methods and formulas, and such apparatus is likewise an object of the present invention. The recitation below discusses the terminology employed herein. In order to achieve the maximum reduction in transmission collisions, the present invention assigns upstream and downstream directionality to network communications, referring to their respective transmissions as upstream transmissions and downstream transmissions. Elements comprising a network of the present invention include transmission paths, a rhythm node, dominant nodes and tonic nodes. Tonic nodes and dominant nodes are situated along transmission paths. In a wired network the rhythm node is situated along a transmission path, and in a wireless network may be situated along a transmission path other than transmission paths along which the tonic nodes and dominant nodes are situated. Tonic nodes are located at one end of the network and dominant nodes at the opposite end. Transmissions from the end at which tonic nodes are located to the end on which dominant nodes are located are termed downstream transmissions. Those in the opposite direction are termed upstream transmissions. The rhythm node is apparatus or functionality that transmits either one of upstream transmission instigation messages and downstream transmission instigation messages, or both of these. Tonic nodes are nodes that perform downstream transmissions upon receiving a downstream transmission instigation message transmitted from the rhythm node. Dominant nodes are nodes that perform upstream transmissions upon receiving an upstream transmission instigation message transmitted from the rhythm node.

An example of a tonic node is a server. An example of a dominant node is a personal computer operating as a client. However, neither is limited to servers or personal computers; internally to a computer, for example, the CPU may be a tonic node and its I/O devices dominant nodes, or where multiple computers are linked to make up a large computing system, a central computer may be a tonic node and computers operating subordinately to it the dominant nodes. It is for this reason that the nomenclature tonic node and dominant node is employed for the present invention. Nor does the present invention restrict location within a network, as servers may be connected as dominant nodes and client personal computers may likewise be connected as tonic nodes. Unless otherwise specified, the transmission paths in the drawings of the present invention are capable of full-duplex transmission.

### Downstream Transmissions

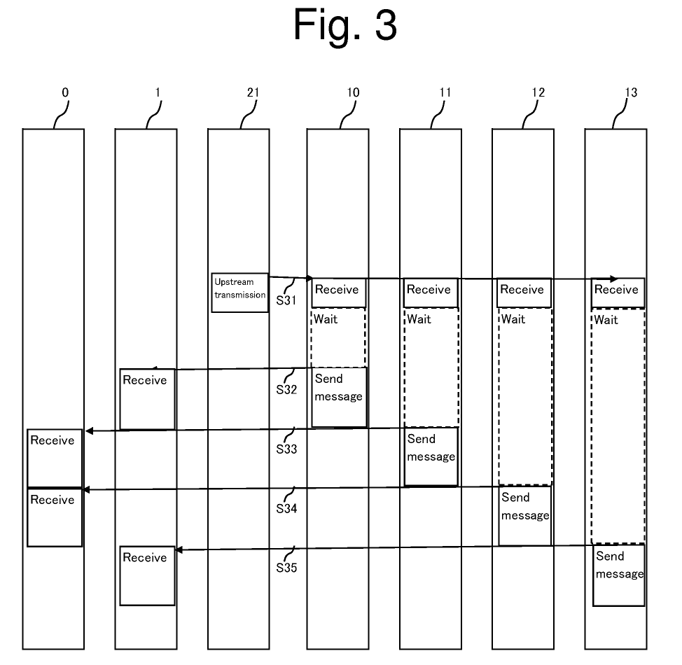

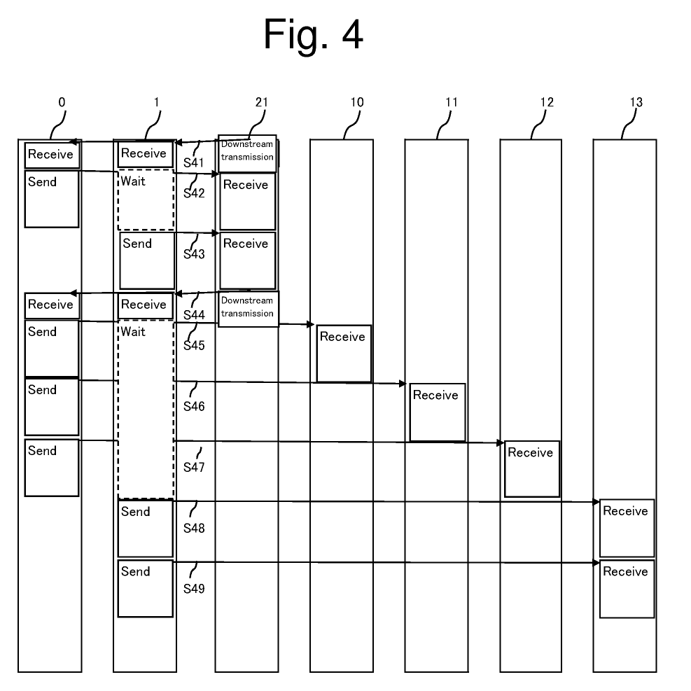

The recitation describes here a concrete method for employing downstream transmission instigation messages to effect downstream transmissions by tonic nodes. The recitation makes reference to the general example of a network in FIG. 2. The recitation makes reference to FIG. 3 and FIG. 4 in first describing a method of employing both downstream transmission query messages and downstream transmission instigation messages. These two drawings chart upstream transmission and downstream transmission respectively, the vertical axis in each representing time, and the time depicted in the two drawings is the same. As time charts, the two ought to be drawn overlaid, but have been split into two due to the difficulty of reading a combined time chart. First, a rhythm node 21 transmits a downstream transmission query message (S41 in FIG. 4). This is performed as a broadcast to tonic nodes. In response to this downstream transmission query message, after their predetermined standby times all tonic nodes transmit to the rhythm node a downstream transmission volume notification message stating the volume of their downstream transmissions (S42 and S43 in FIG. 4). The recitation here describes the predetermined standby time. All tonic nodes are assigned in advance a transmission sequence number for response to downstream transmission query messages. Methods available for assignment of the transmission sequence numbers include that of assigning a fixed number when installing a tonic node and that of assigning a number dynamically when a tonic node boots. Where using a method of assigning numbers dynamically, the transmission sequence number of a tonic node not responding to a downstream transmission query message within a certain period of time should be dynamically terminated.

Transmission of downstream transmission volume notification messages after a predetermined standby time following receipt of a downstream transmission query message is to transmit the downstream transmission volume notification messages sequentially, thereby preventing collisions were the tonic nodes all to transmit their downstream transmission volume notification messages simultaneously. The predetermined standby time may be found from the transmission sequence number as follows. Let the length of the downstream transmission volume notification message transmitted by the individual tonic nodes be a fixed length of F bytes. Let the transmission speed on the transmission paths be S bits/second. Let the standby time then be T nanoseconds. Let the length of transmission paths 60 and 61 be Dn for each. Let the clock deviation of a tonic node be E (+0.00001 where losing one second in 100,000 seconds, and −0.00001 where gaining one second in 100,000 seconds). Let the tonic node transmission sequence numbers be of the series 1, 2, 3 . . . Given standby times of T1 and T2 for tonic nodes 0 and 1, the predetermined standby time is found from Equation A below.

Formula 1

Where n=1, T=0 and

Where n>1, Tₙ=8(1−Eₙ)(2(Dₙ₋₁−Dₙ)/(3×10⁸)+(n−1)F/S) Equation A

Equation A is premised on unambiguous knowledge of the length of transmission paths, but where their lengths are not known unambiguously, collision-less transmissions may be effected by a modified application of the equation such that collisions do not occur where transmission paths are of mixed maximum and minimum lengths. Where hubs are employed, the transmission path length of the equation above is the sum of the length from the tonic node to the hub and the length from the hub to the intermediate communications apparatus. Receipt of a downstream transmission query message is occasion for the individual tonic nodes to transmit downstream transmission volume notification messages addressed to the rhythm node after the predetermined standby time expressed by Equation A. The rhythm node calculates the total volume of downstream transmissions on the basis of the downstream transmission volume notification messages sent from the individual tonic nodes. Let the time required for these downstream transmissions be TT.

The rhythm node calculates the time until transmission of the next upstream transmission instigation message. The upstream transmission performed here is one employing a method of assigning upstream transmission sequence numbers dynamically. This method is for a dominant node to transmit to the rhythm node an upstream transmission permissions request message at the point that dominant node must perform an upstream transmission and the rhythm node then to assign it an upstream transmission sequence number. The predetermined standby time for that upstream transmission sequence number is then calculated, and upon receiving an upstream transmission instigation message, the dominant node transmits its upstream transmission after that predetermined standby time. When upstream transmission messages are exhausted, an upstream transmission permissions cession message is used to cede upstream transmission permissions to the rhythm node. The recitation notes that whereas upstream transmission sequence numbers are termed simply “transmission sequence numbers” in the specification for “A communications system,” herein they are specified as “upstream transmission sequence numbers.”

FIG. 3 and FIG. 4 depict four dominant nodes performing upstream transmission, each performing one frame of upstream transmission. An additional frame is provided for the upstream transmission permissions request message. Given such conditions, it is simple to calculate the time from transmission of an upstream transmission instigation message to completion of upstream transmission in reaction to that upstream transmission instigation message. It is the total of the predetermined standby time and the upstream transmission time of each frame. Let this time be TD. If TD≦(TT−(time from TD origination to present)), downstream transmission permissions are assigned for a downstream transmission volume of TT−(time from TD origination to present) or less. It is efficient to include this assignment of downstream transmission permissions in a downstream transmission instigation message, but it may also be an independent downstream transmission permissions assignment message. Where multiple tonic nodes are present, as is the general case, a single assignment of downstream transmission permissions is made to several tonic nodes.

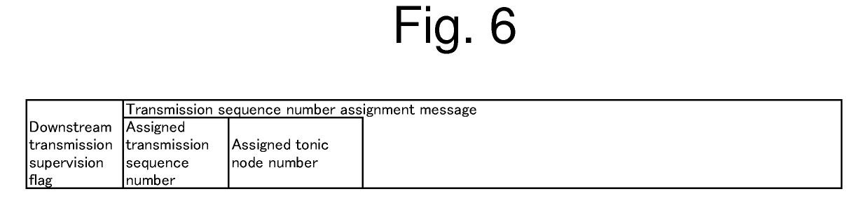

If (TT−(time from TD origination to present))<TD, downstream transmission permissions are allocated for the entire downstream transmission volume requested. FIG. 3 and FIG. 4 depict such an instance. Assignment of downstream transmission permissions takes the form of inclusion in a downstream transmission instigation message (S44 in FIG. 4). Its format is illustrated in FIG. 6. After receiving the downstream transmission instigation message, the individual tonic nodes perform downstream transmissions after their predetermined standby times. Tonic node 0 performs successive downstream transmissions to dominant nodes 10, 11 and 12 (S45 through S47 in FIG. 4). After its predetermined standby time, tonic node 1 performs successive downstream transmissions to a dominant node 13 (S48 and S49 in FIG. 4).

Synchronization with Upstream Transmission Instigation Messages

Proximate to transmission of a downstream transmission instigation message, rhythm node 21 transmits an upstream transmission instigation message to the dominant nodes (S31 in FIG. 3). This is termed synchronization of an upstream transmission instigation message transmission and a downstream transmission instigation message transmission. The simplest form of synchronization is to perform the upstream transmission instigation message transmission and the downstream transmission instigation message transmission simultaneously. However, when transmitting an upstream transmission instigation message, for example, a certain amount of time is required for a dominant node to receive it, to perform the first upstream transmission, and for that upstream transmission message to reach the rhythm node. This amount of time is determined by the distance between the rhythm node and the dominant node. It is sufficient for the downstream transmission instigation message to have completed by the time the first upstream transmission message reaches the rhythm node. In other words, transmission of the downstream transmission instigation message need not be simultaneous with transmission of the upstream transmission instigation message; transmission of the downstream transmission instigation message may follow transmission of the upstream transmission instigation message by a certain amount of time. That time is the time it takes, on transmission of a downstream transmission instigation message, for a tonic node to receive it, to perform the first downstream transmission, and for that that downstream transmission message to reach the rhythm node. The transmission of the upstream transmission instigation message and the downstream transmission instigation message within this space of time, i.e. their synchronized transmission, permits control such that no transmissions on the network cause collisions.

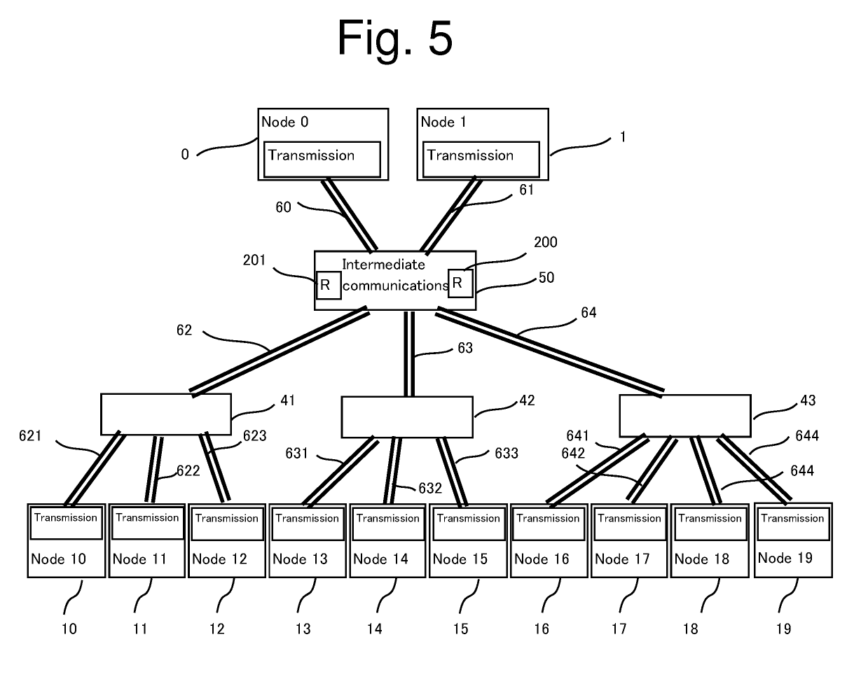

Dominant nodes in receipt of an upstream transmission instigation message perform upstream transmissions upon its receipt and after their predetermined standby times (S32 through S35 in FIG. 3). As noted above, downstream transmissions will likewise have completed at the point when all dominant nodes performing upstream transmissions in response to a single upstream transmission instigation message have completed upstream transmission. In other words, an idle state will obtain. Thus, synchronization of transmission of the upstream transmission instigation message and transmission of the downstream transmission instigation message allows communications in which collisions do not occur between upstream transmissions and downstream transmission instigation or between downstream transmissions and upstream transmission instigation. Nor do collisions occur between upstream transmissions or between downstream transmissions. Here, a single rhythm node may have both functionality for transmission of upstream transmission instigation messages and functionality for transmission of downstream transmission instigation messages, or they may be segregated into a first rhythm node having functionality for transmission of upstream transmission instigation messages to dominant nodes and a second rhythm node having functionality for transmission of downstream transmission instigation messages to tonic nodes. FIG. 5 illustrates an instance of thus employing two rhythm nodes.

Allocation of a downstream transmission volume of (TT−(time from TD origination to present)) or less gives a state in which downstream transmission messages do not fit within a single cycle from a downstream transmission instigation to the next downstream transmission instigation. The next downstream transmission instigation should then specify for transmission to begin with the downstream transmission message next in queue at the time the previous downstream transmissions terminated. Given ten tonic nodes TN0 through TN9 and assignment of downstream transmission permissions to TN0 and TN1 in the cycle immediately prior, for example, if downstream transmission permissions in the next cycle are again assigned beginning with TN0, tonic nodes sequentially afterwards may be unable to perform their downstream transmissions. To avoid such an instance, the tonic nodes assigned downstream transmission permissions in the previous cycle should be recorded and downstream transmission permissions assigned beginning with the next tonic node.

### Predetermined Standby Times

The recitation next discusses the predetermined standby times of tonic nodes. The predetermined standby time is employed in two contexts, tonic node transmissions in response to a downstream transmission query message and tonic node transmissions in response to a downstream transmission instigation message. Predetermined standby times are found as follows. Let the outgoing message lengths of the individual nodes in FIG. 2 be Ln bytes and the transmission speed of transmission paths be S bits/second. Let the standby time then be T nanoseconds. Let the clock deviation of a tonic node be E. The signification is likewise to Equation A. Let the length of transmission paths 60 and 61 be Dn for each. Where tonic nodes 0 and 1 have standby times T₁ and T₂, their standby times are found from Equation B. Where messages are configured as frames required for transmission, L is not the net message length but the total length of one or multiple frames. As with upstream transmission, it is more efficient to allocate multiple frames for downstream transmission, rather than a single frame per session.

Formula 2

Where n=1, T=0 and

Where n>1, Tₙ=Tₙ₋₁+(1−Eₙ)(2(Dₙ₋₁−Dₙ)/(3×10⁸)+8Lₙ₋₁/S) Equation B

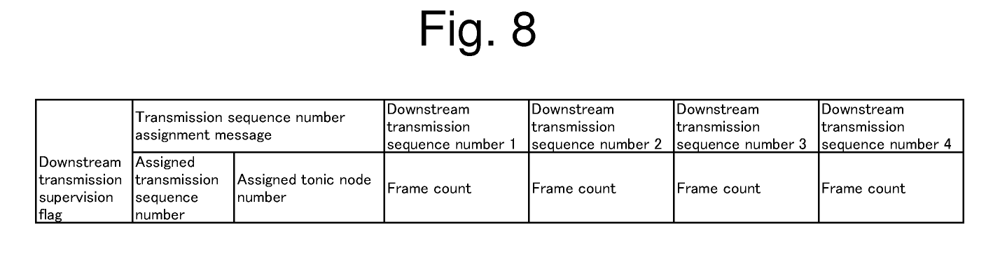

Equation B is premised on unambiguous knowledge of the length of transmission paths, but where their lengths are not known unambiguously, collision-less transmissions may be effected by a modified application of the equation such that collisions do not occur where transmission paths are of mixed maximum and minimum lengths. Where hubs are employed, the transmission path length in Equation B is the sum of the length from the tonic node to the hub and the length from the hub to the intermediate communications apparatus. The above equation may also be applied to the standby times of dominant nodes. Methods of obtaining the transmission message length of a node immediately prior include inserting the transmission message length or frame count for each transmission sequence number into the downstream transmission instigation message, as well as the rhythm node calculating the predetermined standby time of each tonic node and transmitting that information. Where frame counts are inserted, frames should be of fixed length and a message length calculated by multiplying its frame count by the frame length. As the number of messages from tonic nodes in response to a downstream transmission query message is one per tonic node, there is no particular need to include the frame count. FIG. 8 illustrates an example of a downstream transmission instigation message. That shown is an example of utilization of downstream transmission sequence numbers, discussed below.

### Methods of Utilizing Downstream Transmission Instigation Messages Only

While the foregoing recitation describes methods of utilizing both downstream transmission query messages and downstream transmission instigation messages, the following recitation describes methods of utilizing solely downstream transmission instigation messages. Where downstream transmission query messages are utilized, the number of downstream transmission volume notification messages increases with the number of tonic nodes, but the number of tonic nodes performing downstream transmissions at any given time may be reckoned fewer than the total number of tonic nodes. Assigning downstream transmission sequence numbers dynamically to those tonic nodes requiring downstream transmission and transmitting downstream transmission volume notification messages from only those tonic nodes results in fewer downstream transmission volume notification messages in response to a single downstream transmission permissions query message.

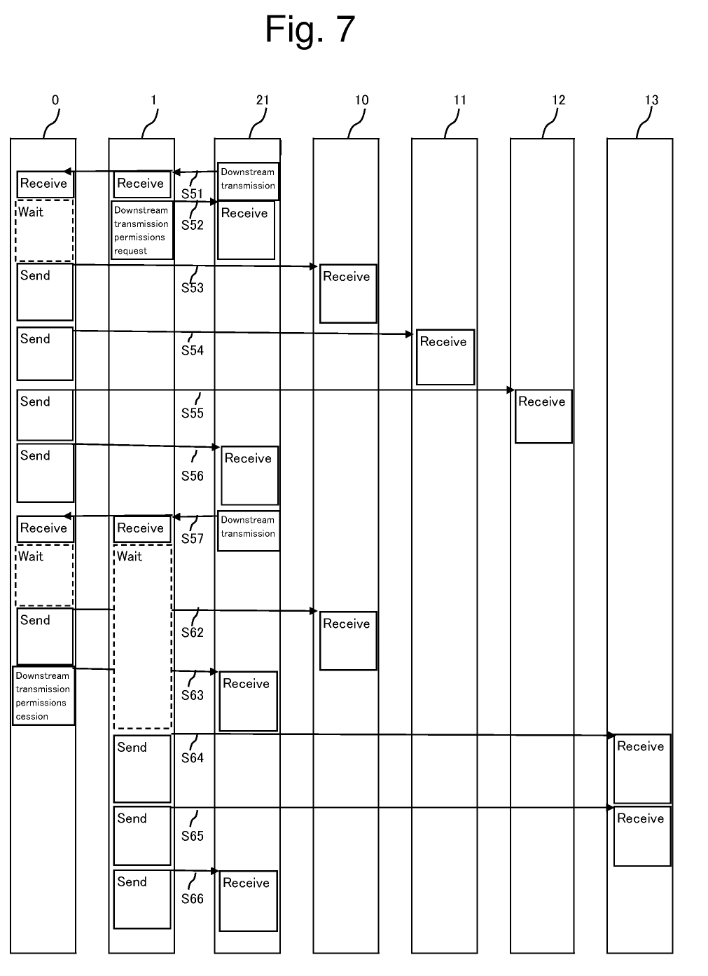

The recitation makes reference to FIG. 7. This drawing illustrates two cycles of downstream transmission. A rhythm node 21 transmits a downstream transmission instigation message (S51). The first frame of downstream transmission is for a downstream transmission permissions request message. Here, a tonic node 1 is transmitting a downstream transmission permissions request message (S52). Upon receipt of that message, the rhythm node assigns a downstream transmission sequence number to tonic node 1. This downstream transmission sequence number is different for each tonic node and is expressed as a node's own downstream transmission sequence number. To record which tonic nodes have a downstream transmission sequence number at a given point in time, a downstream transmission sequence number assignment information storage region is provided that may be updated and that may be referenced by the rhythm node. New assignments of transmission sequence numbers are made to tonic nodes not recorded in this region and then recorded in the transmission sequence number assignment information storage region. An efficient method of notifying a tonic node of its downstream transmission sequence number is to include it in the subsequent downstream transmission instigation message, but it may also be transmitted to that tonic node as a separate message. The number of frames or the message length that tonic nodes having downstream transmission permissions may transmit is inserted in the downstream transmission instigation message.

Tonic nodes receiving the downstream transmission instigation message calculate their predetermined standby times on the basis of information in the downstream transmission instigation message and, after the predetermined standby time following receipt of the downstream transmission instigation message, perform downstream transmissions of the frame count or message length specified. As of the second frame, the individual tonic nodes perform downstream transmissions after their predetermined standby times and in accordance with their downstream transmission sequence numbers. At this point only a tonic node 0 has downstream transmission permissions, and therefore only tonic node 0 is performing downstream transmission. It is performing downstream transmission of one frame to a dominant node 10 (S53), of one frame to a dominant node 11 (S54), and of one frame to a dominant node 12 (S55). Next, it transmits a downstream transmission volume notification message to rhythm node 21 (S56). This completes one cycle of downstream transmission. One cycle of downstream transmission is from the transmission of a downstream transmission instigation message to transmission of the subsequent downstream transmission instigation message.

Next, rhythm node 21 transmits the downstream transmission instigation message of the second cycle (S61). Here, there are no downstream transmission permissions requests. As of the second frame, the individual tonic nodes perform downstream transmissions. Tonic node 1 performs downstream transmission of one frame to dominant node 10 (S62). It then transmits a downstream transmission permissions cession message to the rhythm node (S63). This is for ceding downstream transmission permissions when no further downstream transmissions remain. Receiving this message, the rhythm node 21 revokes the assignment of a downstream transmission sequence number to tonic node 0. Here, the downstream transmission sequence numbers of other tonic nodes having downstream transmission permissions should be reassigned. Tonic node 1 then performs downstream transmission of two frames to a dominant node 13 (S64 and S65). Tonic node 1 then transmits a downstream transmission volume notification message to rhythm node 21 (S66).

### Frame Length

In CSMA/CD systems higher transmission speeds require longer frame lengths for collision detection. Where transmissions are of many short messages, longer frame lengths result in inefficient communications due to the increase in wasted frame regions. However, the two transmissions that entail a possibility of collision in an application of the present invention are those of upstream transmission permissions requests and downstream transmission permissions requests. Where collisions occur here, it is sufficient for the rhythm node to detect these collisions; the individual dominant nodes and tonic nodes need not detect collisions. This is because the result of a collision is the rhythm node not responding with a downstream transmission permissions assignment message or an upstream transmission permissions assignment message and the transmission permissions request unfulfilled for the dominant node or the tonic node. The insertion of some specific bit pattern or CRC in upstream transmission permissions request messages and downstream transmission permissions request messages further facilitates the detection of collisions. This makes it possible to accommodate higher transmission speeds without using longer frame lengths.

### Wireless Communications

The recitation next addresses wireless communications. While “A communications system” describes wireless applications, that recitation focuses on the provision of rhythm-node functionality to a tonic node. However, the rhythm node may be present independently of the tonic nodes and dominant nodes. In a large wireless communications network, the scheme described below is advantageous. In satellite communications, for example, a ground-based antenna may serve as the rhythm node. As satellites are stationed several hundred kilometers from Earth, and geostationary satellites in particular are located at great distances of c.36,000 kilometers from Earth, they are not amenable to utilization of the characteristics of a rhythm node. Designation of a ground-based antenna as the rhythm node gives short distances between the antenna and the dominant nodes. A single rhythm node may provide coverage of an area with a radius of several kilometers to several tens of kilometers, and multiple rhythm nodes may be installed to achieve coverage a broad area. A master rhythm node is installed at the center of the area, and multiple subordinate rhythm nodes installed concentrically with respect to the master rhythm node.

The master rhythm node transmits both or either one of upstream transmission instigation messages and downstream transmission instigation messages to the subordinate rhythm nodes. Tonic nodes and dominant nodes do not receive upstream transmission instigation messages and downstream transmission instigation messages transmitted by the master rhythm node to subordinate rhythm nodes. After receiving both or either one of upstream transmission instigation messages and downstream transmission instigation messages, the subordinate rhythm nodes transmit the upstream transmission instigation messages or downstream transmission instigation messages to the tonic nodes and dominant nodes subordinate to them after their predetermined standby times. The master rhythm node may issue transmissions of upstream transmission instigation messages or downstream transmission instigation messages timed independently, but the subordinate rhythm nodes transmit both or either one of upstream transmission instigation messages and downstream transmission instigation messages after their predetermined standby times following receipt of the upstream transmission instigation message or downstream transmission instigation message from the master rhythm node. That the subordinate rhythm nodes do not transmit both or either one of upstream transmission instigation messages and downstream transmission instigation messages concurrently is to avert collisions in upstream transmissions from dominant nodes subordinate to the rhythm nodes that are concentric from the perspective of the master rhythm node. Where transmitting downstream transmission permissions request messages or downstream transmission permissions assignment messages, the subordinate rhythm nodes transmit these synchronized with the master rhythm node.

### Large Networks

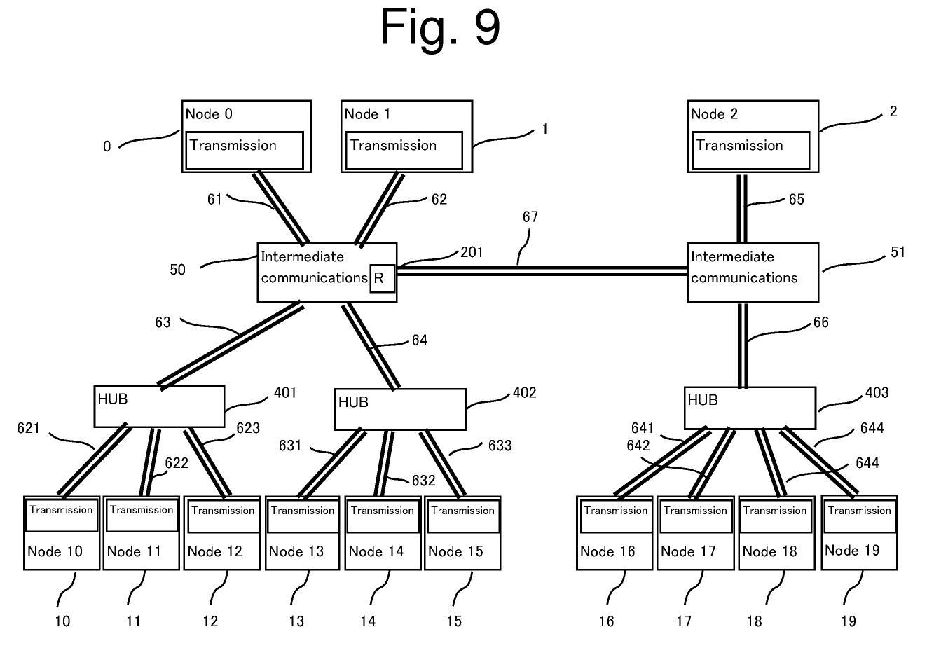

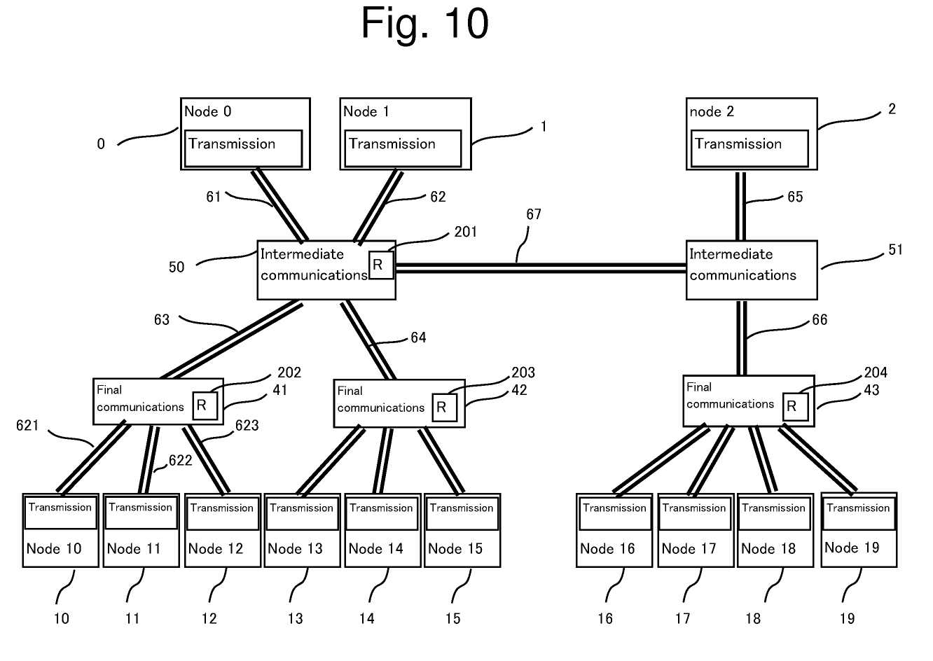

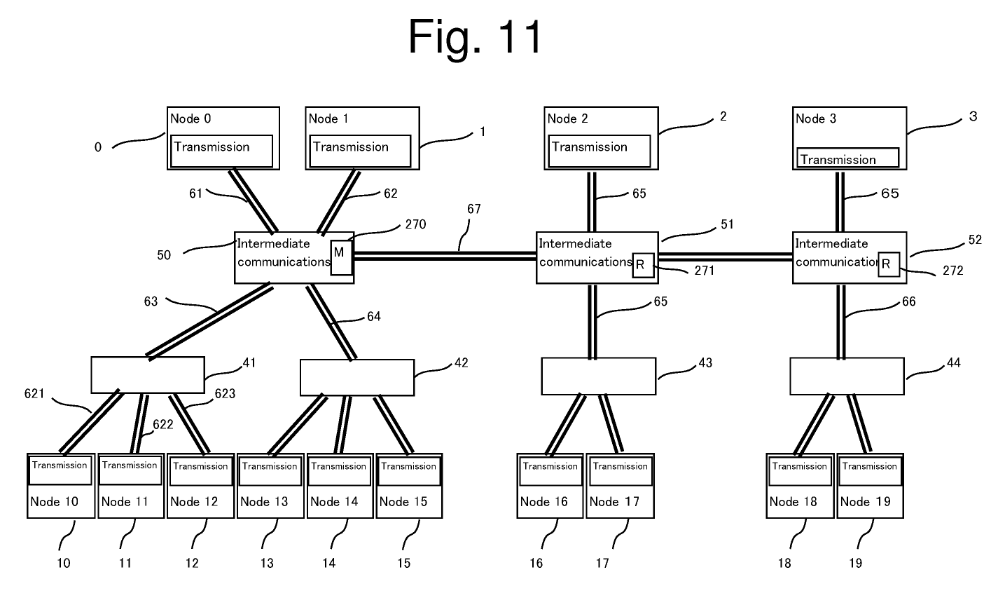

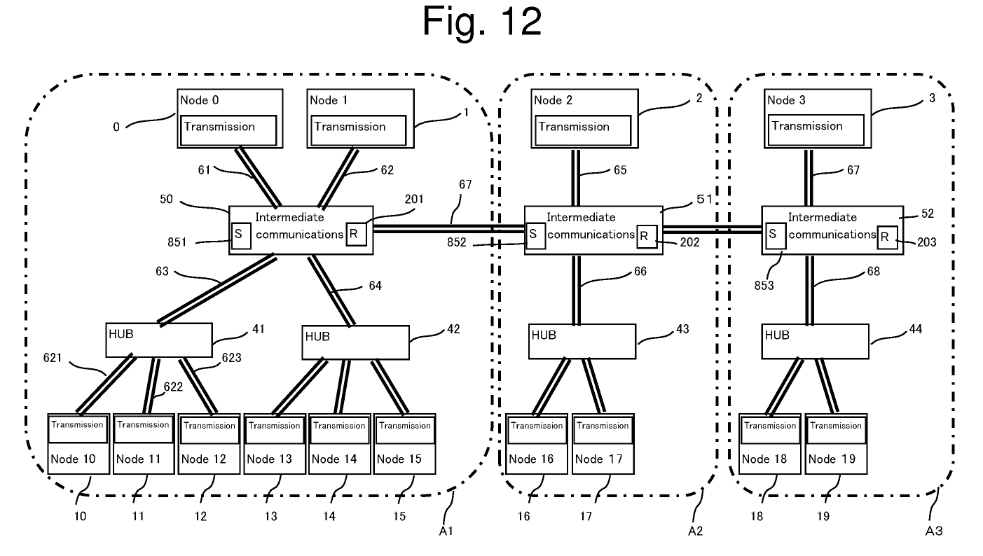

The foregoing recitation primarily discusses relatively small networks, but the present invention is applicable to and of beneficial effect in large networks. The following three methods may be employed in its application to large networks. A first method is, as illustrated in FIG. 9, to implement a single rhythm node or a single array of rhythm nodes for full network coverage. A rhythm node 20 in an intermediate communications apparatus 50 controls the entire network. Or, as illustrated in FIG. 10, final communications apparatuses incorporating rhythm nodes may be employed in a multi-level array of rhythm nodes. A second method is illustrated in FIG. 11. This is a method of employing a single master rhythm node 270 and multiple subordinate rhythm nodes 271 and 272 subordinate to it. This is an application of the recitation relating to wireless communications. Subordinate rhythm nodes 271 and 272 do not operate autonomously; rather, taking the example of a downstream transmission instigation message, after receiving a downstream transmission instigation message from master rhythm node 270, a subordinate rhythm node after its predetermined standby time transmits the downstream transmission instigation message to the tonic nodes that are subordinate to it. Master rhythm node 270 and subordinate rhythm nodes 271 and 272 operate in synchronization. Upstream transmission instigation messages are likewise. A third method is, as illustrated in FIG. 12, to employ multiple intermediate communications apparatuses and link these intermediate communications apparatuses to each other by transmission paths. The intermediate communications apparatuses are provided transmission message storage regions 851, 852 and 853. The nodes within each region bounded by a dotted line (A1, A2 and A3) are taken as a single communications unit. Within a communications unit, individual rhythm nodes 201, 202 and 203 control upstream transmissions and downstream transmissions. Messages between the communications units are enabled by their transmission via transmission message storage regions 851, 852 and 853.

### Intermediate Communications Apparatus for Large Networks

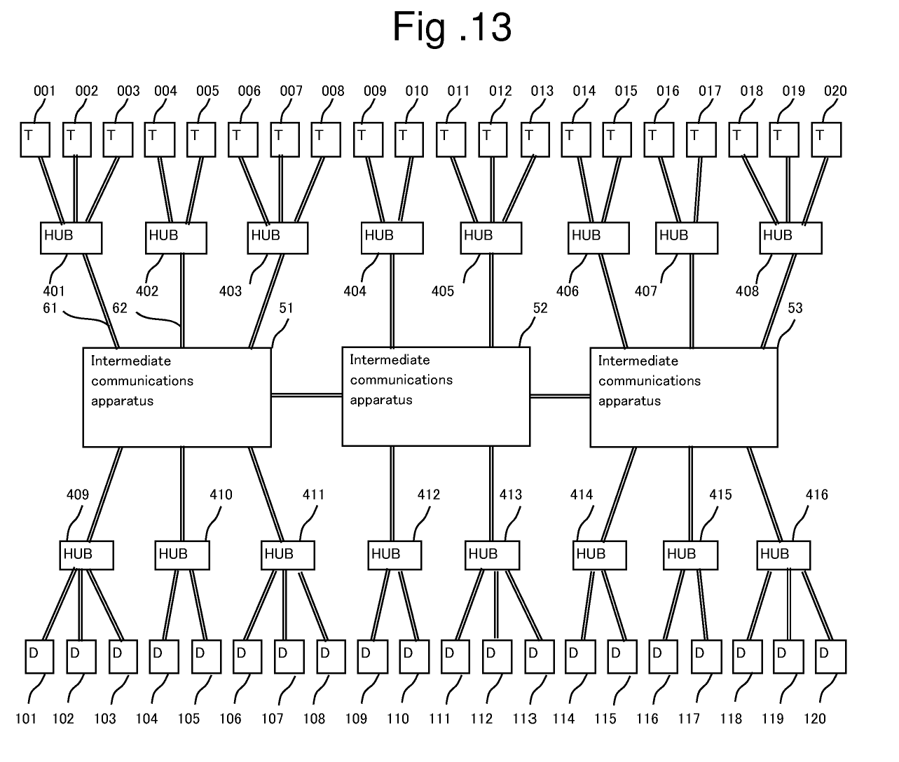

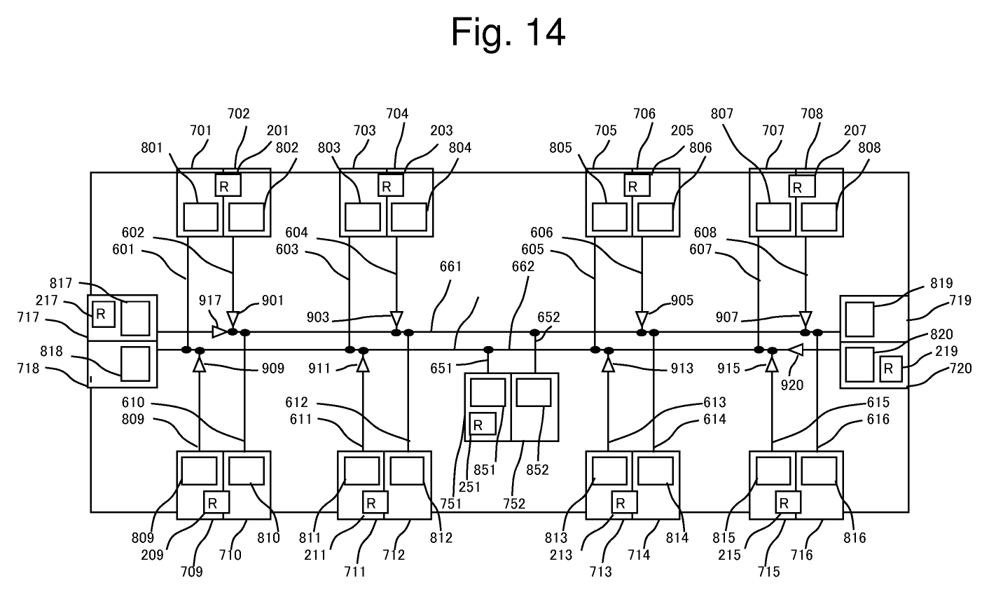

The recitation next describes a further advantageous use of intermediate communications apparatus in large networks. FIG. 13 illustrates an example of a large network that is an object of the present invention. FIG. 14 illustrates an example of an intermediate communications apparatus. An intermediate communications apparatus is equipment for performing transmissions among tonic nodes, dominant nodes, hubs and final communications apparatus. The intermediate communications apparatus of FIG. 14 is provided ten sets of sockets 701 and 702, 703 and 704 . . . 719 and 720. The sockets are instruments provided functionality for links to other nodes, and each set of sockets comprises a rhythm node 201, 203, 205, 207, 209, 211, 213, 215, 217 and 219 and transmission message storage regions 801 and 802, 803 and 804 . . . 819 and 820. The intermediate communications apparatus is provided brokers 751 and 752. The brokers are provided a rhythm node 251 and transmission message storage regions 851 and 852. Thus, the intermediate communications apparatus comprises multiple rhythm nodes. The socket sets 701 and 702, 703 and 704 . . . 707 and 708 of this intermediate communications apparatus are for connection to tonic-node communication lines. The socket sets 709 and 710 . . . 715 and 716 are for connection to dominant-node communication lines. The socket sets 717 and 718, and 719 and 720 are for communication lines for linking to other intermediate communications apparatus. Each socket is connected by means of an internal communication line.

The tonic-node sockets may be linked directly to the tonic nodes, but may also be linked to the tonic nodes via hubs 401, 402, 403 . . . 408, as in FIG. 13. The dominant-node sockets may likewise be linked to the dominant nodes via hubs 409, 410, 411 . . . 416. While this recitation employs the general term “hub”, their functionality differs from common hubs in the following respect. Whereas a common hub may perform internal transmissions from a dominant node to a dominant node and from a tonic node to a tonic node, the hubs employed in the present invention are not enabled to perform such transmissions. This is for the purpose of averting collisions between upstream and downstream transmissions originating outside a given hub and the upstream and downstream transmissions internal to that hub. Additionally, final communications apparatus may be utilized instead of hubs to implement multi-level rhythm nodes.

The recitation describes a concrete method of performing transmissions. The recitation takes the example of socket set 709 and 710. Socket 709 is for performing upstream transmissions from a dominant node. A rhythm node transmits upstream transmission instigation messages from socket 710. Having received an upstream transmission instigation message, the dominant node linked to socket 709 performs upstream transmission to socket 709 after its predetermined standby time. Upstream transmission messages are stored queued in a transmission message storage region 809. Downstream transmissions to the dominant node linked to socket 710 are also performed, synchronously with the transmission of the upstream transmission instigation message. This downstream transmission is of transmission messages stored in a transmission message storage region 810 on a first-in, first-out basis. Downstream transmission is performed over the time through to transmission of the next upstream transmission instigation message. Sockets 711, 712, 713, 714, 715, 716 likewise perform upstream transmission and downstream transmission. Rhythm nodes 209, 211, 213 and 215 may operate synchronously, but may also operate asynchronously. In other words, the transmissions of sockets 709 and 710, sockets 711 and 712, sockets 713 and 714, and sockets 715 and 716 are performed asynchronously.

The recitation describes an implementation of dominant nodes and sockets, but to be more specific in the terminology of the present invention, the sockets are tonic nodes with respect to dominant nodes external to the intermediate communications apparatus. The recitation has noted that “tonic node” and “dominant node” are relative terms, and this is a concrete example thereof. Below the recitation describes transmissions internal to the intermediate communications apparatus, and in transmissions internal to the intermediate communications apparatus the socket set 709 and 710 and the transmission message storage regions 809 and 810 operate as dominant nodes. The same applies to sets of sockets linked to other dominant nodes.

Socket sets 701 and 702, 703 and 704 . . . 708 are linked to tonic nodes. The recitation describes the operation of socket set 701 and 702. A rhythm node 201 transmits downstream transmission instigation messages to socket 701. The tonic nodes linked to socket 701 perform downstream transmissions to socket 702 after their predetermined standby times. Downstream transmission messages transmitted to socket 702 are stored queued in a transmission message storage region 802. Upstream transmissions to the tonic nodes linked to socket 701 are performed synchronously with transmissions of downstream transmission instigation messages. These upstream transmissions consist of transmitting the transmission messages stored in a transmission message storage region 801 on a first-in, first-out basis. Upstream transmission is performed over the time through to the next transmission of a downstream transmission instigation message. Sockets 703, 704, 705, 706, 707 and 708 perform upstream transmission and downstream transmission likewise. Rhythm nodes 201, 203, 205 and 207 may operate synchronously, but their asynchronous operation is more efficient. In other words, the transmissions of socket set 701 and 702, socket set 703 and 704, socket set 705 and 706, and socket set 707 and 708 are performed asynchronously. The intermediate communications apparatus is for performing transmissions among the individual tonic nodes, dominant nodes and hubs; the sockets are for connecting the tonic nodes, dominant nodes and hubs to communication lines in order to perform those communications among them; the transmission message storage regions are for accumulating transmissions from the tonic nodes, dominant nodes and hubs; and the brokers are for effecting reverse link transmissions internal to the intermediate communications apparatus.

The foregoing recitation describes sockets and tonic nodes external to an intermediate communications apparatus; the sockets are dominant nodes with respect to tonic nodes external to the intermediate communications apparatus. In transmissions internal to the intermediate communications apparatus, socket set 701 and 702 and transmission message storage regions 801 and 802 operate as tonic nodes. The same applies to sets of sockets linked to other tonic nodes.

Transmissions to and from nodes external to an intermediate communications apparatus are performed as recited above, and the internal operation of the intermediate communications apparatus is as follows. A rhythm node 251 internal to brokers 751 and 752 performs communications control internal to the intermediate communications apparatus. Internal to the intermediate communications apparatus, socket sets 709 and 710, 711 and 712 . . . 719 and 720 are dominant nodes, and socket sets 701 and 702, 703 and 704 . . . 717 and 718 are tonic nodes. The brokers are special nodes. The method of assigning transmission sequence numbers to individual nodes and the method of obtaining the transmission volumes of individual nodes employed are those recited above.

### Upstream Transmissions Internal to Intermediate Communications Apparatus

The recitation now addresses upstream transmissions internal to an intermediate communications apparatus. Rhythm node 251 transmits an upstream transmission instigation message to sockets 710, 712, 714, 716 and 719, which are dominant nodes, and to broker 752. Upon receipt of the upstream transmission instigation message, socket sets 709 and 710, 711 and 712 . . . 719 and 720, which are dominant nodes, and broker 752 perform upstream transmissions after their predetermined standby times. As it is more efficient in upstream transmissions internal to an intermediate communications apparatus for the dominant nodes each to transmit multiple messages together, rather than a single message, in response to each upstream transmission instigation message, Equation B is used to find the predetermined standby time. Taking into account the lengths of transmission paths 601, 602, 603 . . . 616, 661, 662, amounts corresponding thereto are added to the standby times. Upstream transmission consists of transmitting the transmission messages stored in transmission message storage regions 809, 811, 813, 815, 820 and 852 on a first-in, first-out basis. For example, transmission messages sent from transmission message storage region 809 of socket 709 travel along transmission path 609 and transmission path 662 and then pass to transmission paths 601, 603, 605 and 607. If a transmission message is addressed to itself, sockets 701, 703, 705, 707 and 718 store it queued in their transmission message storage regions 801, 803, 805, 807 and 818. Transmission messages other than those addressed to a node itself are discarded. In terms of socket 801, transmission messages addressed to the node itself are those transmission messages addressed to the full tonic node linked to socket 801.

Simplex communications instruments 909, 911, 913, 915 and 920 are for transmissions to run in a single direction so that transmissions do not run backward. A diode, for example, may be used to create the circuit. When an upstream transmission is performed from socket 709, the transmission messages travel on transmission path 662. Without a simplex communications instrument, the transmission messages would also travel on transmission paths 611, 613 and 615 connected to transmission path 662, and it would be necessary, to avert collision with upstream transmission from sockets 711, 713, 715 and 720, to lengthen predetermined standby times by amounts corresponding to electrical flow over the lengths of transmission paths 611, 613 and 615. Due to the presence of the simplex communications instrument, transmissions from socket 709 do not travel on transmission paths 611, 613 and 615, permitting shorter predetermined standby times.

### Downstream Transmissions Internal to Intermediate Communications Apparatus

The recitation next discusses downstream transmission. Rhythm node 251 transmits downstream transmission instigation messages synchronized with transmission of upstream transmission instigation messages. Upon receipt of a downstream transmission instigation message, socket sets 701 and 702, 703 and 704 . . . 717 and 718, which are tonic nodes, and brokers 751 and 752 perform downstream transmission after their predetermined standby times. Equation B is used to find their predetermined standby times, and taking into account the lengths of transmission paths, amounts corresponding thereto are added to their standby times. The dominant nodes collect transmission messages addressed to their own node and store them queued in transmission message storage regions 810, 812, 814, 816 and 819. Brokers 751 and 752 receive messages addressed to tonic nodes and store them in transmission message storage region 852. The total time of downstream transmissions is equivalent to the total time of upstream transmissions, and transmissions of downstream transmission instigation messages and upstream transmission instigation messages are synchronized.

### Brokers Internal to Intermediate Communications Apparatus

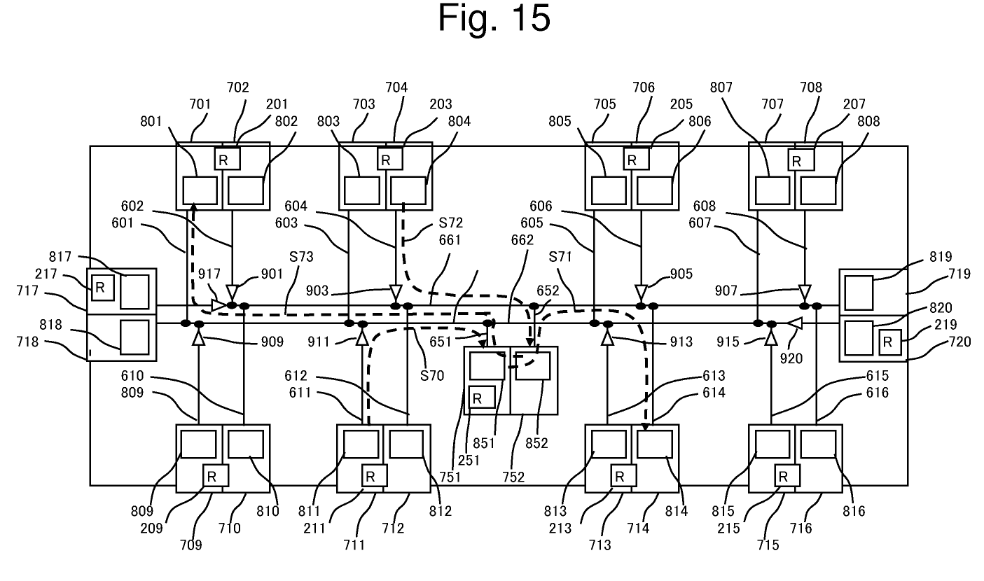

The recitation first makes reference to FIG. 15 in discussing brokers 751 and 752. The brokers are special nodes internal to the intermediate communications apparatus. Where configured as illustrated in FIG. 13, it is not possible to make transmissions from a tonic node to a tonic node or from a dominant node to a dominant node, but the brokers constitute functionality that implement such transmissions. They may be termed a reverse link transmission instrument. For example, a transmission from dominant-node socket 711 to socket 714 is received for the time being by brokers 751 and 752, and stored in transmission message storage region 851 (S70 in FIG. 15). The procedure is next for broker 752 to transmit data in transmission message storage region 851 as downstream transmission on a transmission path 652 and for socket 714 to receive that message (S71 in FIG. 15).

Likewise, a transmission from tonic-node socket 704 to socket 701 is received by brokers 751 and 752 and stored in transmission message storage region 852 (S72 in FIG. 15). Next, brokers 751 and 752 transmit the data in transmission message storage region 852 as upstream transmission on a transmission path 651, and socket 701 receives it (73 in FIG. 15). Brokers 751 and 752 are special dominant nodes, and when other dominant nodes internal to their own intermediate communications apparatus are performing upstream transmissions, they receive messages addressed to dominant nodes internal to their own intermediate communications apparatus and store them in transmission message storage region 851. At this time brokers 751 and 752 behave as though they were tonic nodes. When performing upstream transmission, brokers 751 and 752 send the transmission messages stored in transmission message storage region 852.

When tonic nodes internal to their intermediate communications apparatus are performing downstream transmissions, the brokers receive messages addressed to tonic nodes internal to their intermediate communications apparatus and store them in transmission message storage region 852. When performing downstream transmission, broker 752 sends transmission messages stored in transmission message storage region 851. Thus, the brokers have the functionality of both tonic nodes and dominant nodes, and they perform transmissions upon receipt of either an upstream transmission instigation message or a downstream transmission instigation message from rhythm node 251 and after their predetermined standby times. In downstream transmissions they send messages stored from upstream transmissions, and in upstream transmissions they send messages stored from downstream transmissions.

### Transmission Message Storage Regions

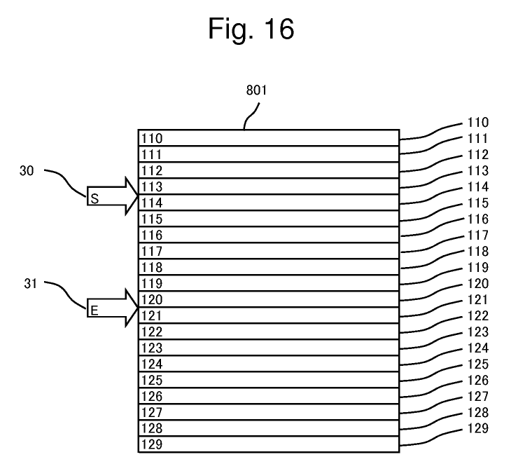

The recitation next describes a method of storing transmission messages queued in transmission message storage regions and transmitting them on a first-in, first-out basis. FIG. 16 is an example of a transmission message storage region 801. The region is provided two pointers, a start pointer 30 and an end pointer 31. When a new transmission message is added to the field, the transmission message is stored immediately past the position pointed to by end pointer 31, and end pointer 31 is modified to point immediately past the new transmission message. Transmission of transmission messages on a first-in, first-out basis is executed by reading transmission messages in sequence beginning with that message immediately past start pointer 30. Once transmission of transmission messages has completed, start pointer 30 is modified to point immediately past the transmission messages that have completed transmission. Thus, transmission messages are stored in the transmission message storage region in memory areas 114 to 120 between the start pointer and the end pointer.

When end pointer 31 reaches the end of transmission message storage region 801 (past a memory area 129), the end pointer is made to point to the head of the transmission message storage region. In such event, the transmission messages stored are those between the start pointer and the end of the transmission message storage region and then between the head of the transmission message storage region and the end pointer. Setting a flag in one of the memory areas to indicate that the end pointer has returned to the head increases the probability that the reversed positional relationship of the start pointer and the end pointer will be recognized. When the start pointer returns to the head, this flag is reset. The end pointer is unable to overtake the start pointer. This is because if such were to occur, not only would the positional relationship of the pointers become unknown, but part of the storage region would suffer damage. Where such does occur, the further storage of messages is suspended and transmission messages discarded until the storage region can be utilized. Discarded messages are resent according to the transmission protocol. Storage regions should be of size and the transmission speeds of intermediate communications apparatus of rate sufficient to avoid the discarding of transmission messages.

Messages read from a transmission message storage region and transmitted should be deleted from the transmission message storage region, and it is sufficient to delete transmission messages by moving the start pointer. While FIG. 16 illustrates handling of fixed-length transmission messages, this is to simplify the drawing, and messages of variable length may be handled in like fashion. The volume of the transmission messages between the start pointer and the end pointer may be utilized as the value of transmission volume notification messages. However, the value of a transmission volume notification message should be that subsequent to configuration as frames. Otherwise, calculation of transmission volume is performed by the rhythm node. FIG. 13 gives an example of intermediate communications apparatuses arranged laterally; longitudinal arrangements of multiple intermediate communications apparatuses may be employed to enable application to larger networks. A redundant configuration may also be implemented.

### Priority Messages

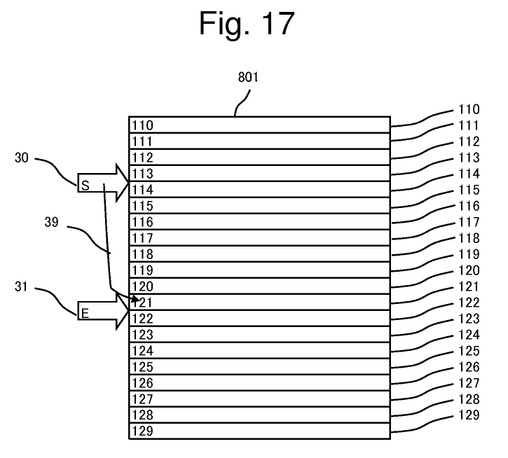

Some transmission messages should be prioritized. For example, because delays in transmission of audio frames result in choppy audio, their transmission should be prioritized over other frames. Such transmission of prioritized frames may be achieved by a method such as shown in FIG. 17. In FIG. 17 regular transmission messages are stored from a memory area 114 through a memory area 120. If a priority message is generated, that transmission message is stored in a memory area 121. Start pointer 30 is provided two memory areas, one of which is used to point to a regular message and the other of which is used to point to the priority message. It would then be made to point to memory area 114 and to the head of memory area 121. If transmission messages are read on a first-in, first-out basis, the transmission message stored in memory area 121 is read first because start pointer 30 is pointing to memory area 114 and to memory area 121; read next is the transmission message in memory area 114 pointed to by the start pointer, and next read is the transmission message in memory area 115. Where a priority message spans multiple frames, the plurality may be accommodated by chaining the frames.

Utilizing such a method permits the prioritization of specific messages. In such event, an identifier should be prepended to the transmission message in memory area 121 so that it is not transmitted redundantly. Start pointer 30 should be capable of storing both the address of the start of a regular message and the address of the start of a priority message.

### Nonexistent Upstream Transmissions

Where upstream transmissions are entirely nonexistent at some given time in communications utilizing a transmissions procedure and communications system such as recited above, upstream transmission permissions request messages alone are the objects of upstream transmission for a single upstream transmission instigation message. However, issuing repeated upstream transmission instigation messages in such circumstance would shorten the intervals between upstream transmission instigation messages and may render the system unable to perform downstream transmissions efficiently. In such event, issue of the next upstream transmission instigation message should be timed for, e.g., ten frames to enable efficient downstream transmissions. Likewise, where upstream transmissions are lower in volume than downstream transmissions, issue of the next upstream transmission instigation message should be delayed so that downstream transmissions are performed efficiently.

### Quarantine System

The recitation has already discussed the assignment of downstream transmission sequence numbers and upstream transmission sequence numbers to assign downstream transmission permissions and upstream transmission permissions, and this functionality may be employed to easily construct a so-called quarantine system. Various measures have been applied to prevent unauthorized nodes added to a network from transmitting on that network. However, utilization of the present invention permits the creation of a state in which such nodes are entirely unable to transmit on the network by requiring of downstream transmission permissions requests and upstream transmission permissions requests the inclusion of unique information, such as a node's identifying information (e.g. its CPU ID), and the rhythm node refusing downstream transmission permissions requests and upstream transmission permissions requests made by nodes lacking that information or by nodes not registered with the rhythm node. As dominant nodes may be displaced through physical removal, they should identified to the entire closed network and not only to the rhythm node.

### REFERENCE NUMERALS IN DRAWINGS

0, 1, 3 . . . Tonic nodes
001, 002, 003 . . . 020 . . . Tonic nodes
10, 11, 12 . . . 19 . . . Dominant nodes
101, 102, 103 . . . 120 . . . Dominant nodes
20, 21, 22, 23 . . . Rhythm nodes
41, 42, 43, 44 . . . Final communications apparatuses
401, 402, 403 . . . 416 . . . Hubs
50, 51, 52 . . . Intermediate communications apparatuses
61, 62, 63, 64, 65, 66 . . . Transmission paths
200, 201, 203, 205 . . . 219, 251 . . . Rhythm nodes
270 . . . Master rhythm node
271, 272 . . . Subordinate rhythm nodes
601, 602, 603 . . . 616, 661, 662 . . . Transmission paths
701, 702, 703 . . . 720 . . . Sockets
801, 802, 803 . . . 820, 851, 852 . . . Transmission message storage regions
901, 903, 905 . . . 917, 920 . . . Simplex communications instruments
110, 111, 112 . . . 129 . . . Memory areas
S1 through S63 . . . Transmission messages

What we claim is:

1. A communications system, comprising:
a rhythm node that transmits upstream transmission instigation messages and downstream transmission instigation messages,
multiple dominant nodes that transmit data upon receipt of an upstream transmission instigation message, multiple tonic nodes that transmit data upon receipt of a downstream transmission instigation message, and
transmission paths,
said rhythm node transmits upstream transmission instigation messages, data is sent in upstream transmission from each dominant node upon receipt of an upstream transmission instigation message by the dominant node and after a predetermined standby time maintained individually for each dominant node, the rhythm node transmits downstream transmission instigation messages, and data is sent in downstream transmission from each tonic node upon receipt of a downstream transmission instigation message and after a predetermined standby time maintained for each tonic node, and
said transmission of upstream transmission instigation messages and transmission of downstream transmission instigation messages are synchronized.

2. The communications system of claim 1, further comprising
each tonic node having its own downstream transmission sequence number and transmitting data signals upon receipt of a downstream transmission instigation message from the rhythm node after the predetermined standby time and in accordance with its downstream transmission sequence number.

3. The communications system of claim 1, further comprising
a downstream transmission sequence number assignment information storage region, for assignment of downstream transmission sequence numbers to tonic nodes, that may be updated and that may be referenced by the rhythm node.

4. The communications system of claim 1, further comprising
rhythm nodes comprising one master rhythm node and multiple subordinate rhythm nodes;
said master rhythm node transmits to subordinate rhythm nodes either one or both of upstream transmission instigation messages and downstream transmission instigation messages, and each subordinate rhythm node transmits either one or both of upstream transmission instigation messages and downstream transmission instigation messages upon receipt from the master rhythm node of either one or both of upstream transmission instigation messages and downstream transmission instigation messages and after its predetermined standby time.

5. The communications system of claim 1, further comprising:
intermediate communications apparatus that communicates with individual tonic nodes and individual dominant nodes;
said intermediate communications apparatus contains multiple sockets that communicate with tonic nodes, dominant nodes, the intermediate communications apparatus or hubs; multiple transmission message storage areas that accumulate transmissions from tonic nodes, dominant nodes, the intermediate communications apparatus or hubs; and multiple rhythm nodes; and
said intermediate communications apparatus contains brokers that effect reverse link transmissions internal to the intermediate communications apparatus.

6. A communications method, comprising:
a rhythm node that transmits upstream transmission instigation messages and downstream transmission instigation messages, multiple dominant nodes that transmit data upon receipt of an upstream transmission instigation message, multiple tonic nodes that transmit data upon receipt of a downstream transmission instigation message, and transmission paths,
said rhythm node transmits upstream transmission instigation messages, data is sent in upstream transmission from each dominant node upon receipt of an upstream transmission instigation message by the dominant node and after a predetermined standby time maintained individually by each dominant node, the rhythm node transmits downstream transmission instigation messages, and data is sent in downstream transmission from each tonic node upon receipt of a downstream transmission instigation message and after a predetermined standby time maintained by each tonic node; and
said transmission of upstream transmission instigation messages and transmission of downstream transmission instigation messages are synchronized.
